(19) United States
(12) Patent Application Publication
(10) Pub. No.: US 2012/0141795 A1
(43) Pub. Date: Jun. 7, 2012

(54) BISMUTH VANADATE PARTICLES AND THE METHOD FOR PRODUCING SAME

(75) Inventors: Tamar Saison, Paris (FR); Nicolas Chemin, Bagneux (FR); Corinne Chaneac, Bagnolet (FR); Olivier Durupthy, Nogent-Sur-Marne (FR); Jean-Pierre Jolivet, Saint-Pierre De Chignac (FR)

(73) Assignees: SAINT GOBAIN GLASS FRANCE, Courbevoie (FR); CENTRE NATL. DE LA RECHERCHE SCIENTIFIQUE, Paris (FR); UNIVERSITE PIERRE ET MARIE CURIE, Paris (FR)

(21) Appl. No.: 13/389,710

(22) PCT Filed: Aug. 30, 2010
(86) PCT No.: PCT/FR10/51794

§ 371 Date: Feb. 9, 2012

(30) Foreign Application Priority Data
Aug. 31, 2009 (FR) 0955921

(51) Int. Cl. C01G 29/00; C01B 33/12; B82Y 30/00; B82Y 40/00

(52) U.S. Cl. 428/402; 423/594.7; 423/326; 977/773; 977/896

(57) ABSTRACT

The subject of the invention is a method for obtaining particles of chemical formula BiVO₄ wherein bismuth and vanadium precursors and at least one additive chosen from surfactants of the sulphate or phosphonate type comprising at least one hydrocarbon chain are made to react at a temperature below 50° C. The subject of the invention is also particles of chemical formula BiVO₄ of which the surface has Brønsted sites.

The invention relates to the field of photocatalytic particles made of bismuth vanadate of formula BiVO₄.

Bismuth vanadate BiVO₄ is known for its photocatalytic properties. It is in particular valued for the fact that its properties are activated by visible light. Under the action of visible radiation, electron-hole pairs are created, which will contribute to the catalysis of redox reactions, notably leading to the degradation of organic compounds. The result of this is anti-soiling, decontaminating or bactericidal properties.

Yang et al (Material Chemistry and Physics 114, 2009, pp 69-72) describe the hydrothermal synthesis of BiVO₄ particles at temperatures of 180° C. to 220° C. Under these synthetic conditions, addition of a surfactant, sodium dodecylsulphate (SDS), makes it possible to improve crystallization in the monoclinic scheelite phase.

The inventors have now demonstrated that carrying out synthesis at a lower temperature under conditions that do not fall within those of hydrothermal synthesis, enables original particles to be obtained having super-acid properties inducing more effective mechanisms for the degradation of organic compounds.

The subject of the invention is therefore a method for obtaining particles of formula BiVO₄ wherein bismuth and vanadium precursors and at least one additive chosen from surfactants of the sulphate or phosphonate type comprising at least one hydrocarbon chain are made to react at a temperature below 50° C.

The subject of the invention is also particles of chemical formula BiVO₄ of which the surface contains Brønsted sites. The particles are notably able to be obtained by the method according to the invention.

The chemical formula of the particles obtained may vary slightly compared with the strict formula BiVO₄. Notably, the molar ratio Bi/V may typically vary between 0.96 and 1.04. The stoichiometry in oxygen may also vary slightly without for all that departing from the scope of the invention.

The reaction preferably takes place at ambient temperature, notably between 15 and 30° C., preferably between 20 and 25° C. The reaction is preferably carried out at atmospheric pressure.

The reaction preferably takes place in aqueous solution, which avoids the use of toxic solvents or solvents prejudicial to the environment.

A single bismuth precursor and a single vanadium precursor are preferably used. These precursors are preferably salts or oxides.

At least one bismuth precursor is chosen from bismuth nitrates or chloride. Bismuth nitrate pentahydrate is particularly preferred. At least one vanadium precursor is preferably chosen from ammonium vanadate or sodium vanadate. Vanadium oxide may also act as a precursor.

The hydrocarbon chain of the additive of the sulphate or phosphonate type is preferably a linear or branched alkyl chain containing between 6 and 20 carbon atoms, notably between 10 and 16 carbon atoms. A sufficiently long hydrocarbon chain makes it possibly to slow down the transformation from the quadratic phase to the monoclinic phase. The counter-ion of the additive may for example be the sodium ion (Na⁺), lithium ion (Li⁺), potassium ion (K⁺) or ammonium ion. It may also be a proton (H⁺), if indeed “sulphate” or “phosphonate” are also understood to cover conjugated acids. Sodium dodecylsulphate and tetradecyl phosphonic acid have proved to be particularly advantageous.

Under the non-hydrothermal conditions used according to the invention, the additive has proved to be capable of creating Brønsted acid sites on the surface of the particles. The presence of these sites leads to very strong adsorption of organic compounds on the surface of the particles, which brings about more rapid degradation of these compounds via a more effective degradation mechanism. The presence of the additive additionally makes it possible to create a particular morphology and to increase considerably the specific surface area of the particles.

The relative proportion of bismuth and vanadium precursors is preferably chosen so that the atomic ratio Bi/V lies between 0.9 and 1.1, notably between 0.95 and 1.05. A ratio equal to 1 is preferred. These conditions make it possible to promote the formation of the BiVO₄ phase, while preventing the other definite compounds from being formed.

The molar concentration in vanadium and/or in bismuth preferably lies between 0.01 and 0.5 mol/L, notably between 0.05 and 0.2 mol/L. The concentration of the additive preferably lies between 0.005 and 0.05 mol/L, notably between 0.008 and 0.02 mol/L. The pH during the reaction is generally acid, typically below 2 or even close to 1.

The duration of the reaction may vary from a few hours to a few days, typically from 2 hours to 1 week.

At the end of the reaction, the particles are recovered by known techniques, for example by centrifuging. The particles are preferably washed.

The presence of Brønsted sites may be determined by infrared spectroscopy, after putting the particles into contact with pyridine. The Brønsted sites will lead to the protonation of pyridine, associated with the presence of peaks in the region of the following wavelengths: 1640 cm⁻¹, 1540 cm⁻and 1490 cm⁻¹.

The presence of these sites leads to a strong adsorption of organic compounds, notably pyridine. The result is notably a temperature for the complete desorption of chemisorbed pyridine above 150° C. This temperature may be determined by bringing a sample of the particles put into contact with pyridine to various temperatures and evaluating the presence of pyridine by infrared spectroscopy, according to an experimental protocol detailed in the remainder of the text.

The presence of Brønsted sites also results in an excess concentration of bismuth in the extreme surface of the particles. This excess concentration leads notably to Bi/V ratios measured by X-ray photoelectron spectroscopy (XPS) greater than 1.5, notably greater than 1.7.

The average diameter of the particles is preferably between 500 nm and 5 micrometres, notably between 700 nm and 2 micrometres. As demonstrated hereinafter, addition of the additive makes it possible to obtain very high specific surface areas in spite of the micrometric size of the particles. It is therefore no longer necessary to use nanometric particles, which may present toxicological problems linked to their capacity to be inhaled. Moreover, small sized nanoparticles may be less effective in terms of photocatalysis since facilitating electron-hole recombinations.

The particles obtained have a gap of approximately 2.4 eV between the conduction band and the valence band. Radiation of which the wavelength is of the order of 515 nm is thus capable of activating photocatalytic reactions.

The particles according to the invention preferably comprise monoclinic phase crystals of the scheelite type and quadratic phase crystals of the zircon type. Even though the more active phase as regards photocatalysis is the scheelite phase, it seems that the presence of the other phase makes it possible to increase photocatalytic efficiency. This effect, perhaps due to better separation between electrons and holes, has notably been described in relation to titanium oxide, for which mixtures of anatase and rutile phases prove to be particularly active, while the rutile phase has in itself low activity. The monoclinic phase is preferably the major one in the sense that its mass proportion is greater than 50%, notably 60% or 65%.

The specific surface area of the particles, determined by nitrogen adsorption with the aid of the BET method, is preferably greater than or equal to 10 m²/g.

The subject of the invention is also a substrate coated with at least one layer comprising particles obtained by the method according to the invention or comprising particles according to the invention.

The particles are preferably bound to the substrate by means of an inorganic binder. Organic binders are in point of fact liable to be degraded rapidly by the photocatalytic action of BiVO₄ particles.

The inorganic binder is preferably based on an oxide, notably silica. It may consist of silica, notably obtained by a sol-gel type method. To this end, organometallic precursors, for example tetraethoxyorthosilicate (TEOS), condense at the surface of the substrate. The sol may be deposited by dip-coating, cell-coating or spray-coating. A heat treatment step is generally necessary for removing solvent, for densifying the layer and making it mechanically strong. In order to facilitate access to the particles by contaminating species, the binder, notably silica, may be made porous. It may notably have mesopores, of which the pores have a diameter between 2 and 50 nm. Such mesopores may be obtained with the aid of a structuring agent or “template”, generally based on amphiphilic molecules such as surfactants or block copolymers. These agents have the ability to organize themselves into micelles around which the precursors will precipitate and condense. Other metal oxides, such as alumina or zirconia, may also be obtained by a similar method and serve as a binder.

The binder may also be based on silanes or silicones.

The substrate is preferably made of glass and is notably a sheet of glass. Any type of material may however be used, such as a ceramic, metal or polymeric organic material, notably in the form of sheets, films or fibres. The substrate is preferably transparent or translucent. For this reason, glass or polymeric organic materials such as polycarbonate or polymethyl methacrylate are preferred. Preferably, the glass sheet has at least one dimension greater than 1 metre, or even 2 or 3 metres. Its thickness is preferably between 0.5 and 19 mm, notably between 3 and 9 mm. The glass may be notably of the soda-lime-silica, or borosilicate or aluminoborosilicate type. The glass may be clear or extra clear or coloured, for example blue, bronze, grey, amber, pink etc. The glass sheet may notably be annealed, hardened, toughened or curved. The substrate may be flat or curved.

Apart from the layer containing the particles according to the invention, the substrate may be coated, on the same face or on the other face, with at least one other layer or even a stack of layers.

It may consist for example of a layer or low-emission stack (notably comprising at least one silver layer), which controls sunlight, is antireflecting, antistatic, a conductor of electricity, reflecting (for example a layer of silver for a mirror) or may consist of a layer of paint or lacquer. It is possible in particular to deposit one or more sub-layers under the layer containing the particles according to the invention. It may notably consist of layers that are a barrier to the migration of alkalis coming from the substrate, which may constitute a poison for photocatalysis. It may also consist of a layer or several layers designed to attenuate light reflected from the layer containing the particles according to the invention and/or to obtain a neutral or slightly bluish tint in reflection. In this case, interference phenomena are preferably employed by alternating layers with a high and low refractive index.

The layer containing the particles according to the invention is preferably the layer that is furthest away from the substrate, and is thus in contact with the ambient air. In this way, it will be more able to interact with atmospheric pollutants and to fulfill its decontaminating or self-cleaning function.

The subject of the invention is also glazing, notably for buildings, vehicles or furniture, a mirror, a wall covering made of glass, a door or a glass partition, comprising at least one substrate according to the invention.

The glazing may notably be single or multiple (for example double or triple glazing) or may be laminated.

Such glazing has self-cleaning, antifouling and bactericidal or decontaminating or deodorizing properties. Since it is activated by visible light, it may fulfill its function including that inside buildings or vehicles, where ultraviolet radiation is low.

These properties may also be used to advantage in materials other than glazing. The layers comprising particles according to the invention may be notably deposited on the surface of fibrous materials, such as mineral wools, felts, mats, fabrics, woven or non-woven webs, in particular to act as filters.

The invention will be better understood on reading the following non-limiting examples of embodiments.

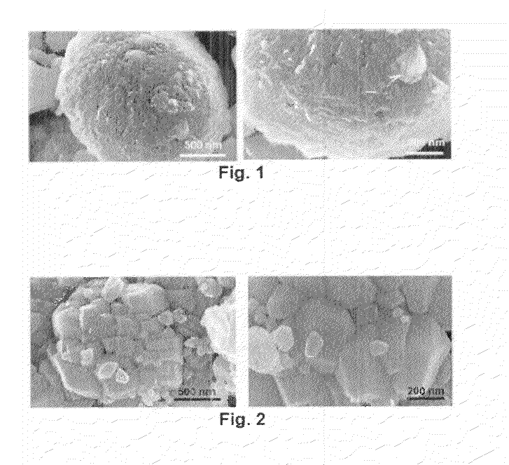

FIG. 1 is a scanning electron photomicrograph of a particle according to the invention.

FIG. 2 is a scanning electron photomicrograph of a comparative particle.

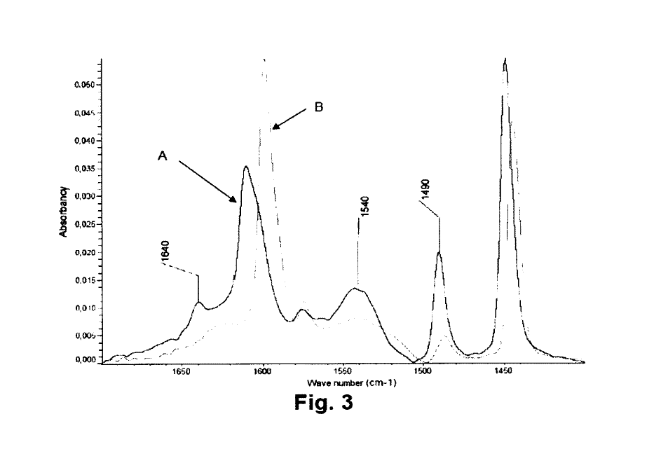

FIG. 3 is the superimposition of two infrared spectra, of particles according to the invention and comparative particles respectively.

25 mL of an aqueous solution A was prepared containing bismuth nitrate pentahydrate Bi(NO₃)₃.5H₂O in a 1.5 M nitric acid solution.

In addition, 25 mL were prepared of an aqueous solution B containing sodium vanadate NaVO₃. The concentrations of bismuth and vanadium in their respective solutions were 0.2 M.

0.146 g of sodium dodecyl sulphate (SDS) were added to the solution A.

The two solutions were then mixed and kept at ambient temperature for one week with magnetic stirring.

The particles formed were recovered by centrifuging, washed with water and then dried under a stream of nitrogen.

A comparative sample was obtained in an identical manner, the only exceptions being the absence of the addition of SDS and the fact that the vanadium precursor was V₂O₅. Samples were also prepared using the same precursor as for the sample according to the invention, and proved to have even lower photocatalytic activity than that of the comparative sample.

X-ray diffraction analysis showed that the particles contained approximately 70% by weight of a monoclinic phase of the scheelite type and 30% by weight of a quadratic zircon phase.

The specific surface area as determined by nitrogen adorption with the aid of the BET method was 12 m²/g. The specific surface area of the comparative sample was below 3 m²/g.

The morphology of the particles according to the invention is illustrated in FIG. 1. It was possible to observe texturizing of the surface in very characteristic thin leaves. This particular morphology was very different from that by FIG. 2 when compared with particles of the comparative sample, synthesized without the addition of SDS. The morphology was also very different from that obtained by Yang et al. (Material Chemistry and Physics 114, 2009, pp 69-72) with the aid of hydrothermal synthesis.

The Bi/V ratio measured by X-ray photoelectron spectroscopy (XPS) was 1.8, which resulted from a large excess concentration of bismuth at the extreme surface of the particles. The crystallographic surface planes were thus planes rich in bismuth. On the contrary, the same ratio, measured for the comparative sample, was only 1.3.

This excess concentration was probably associated with higher surface acidity and to the presence of Brønsted sites in the surface of the particles.

The presence of Brønsted sites was demonstrated in the following way:

Pellets obtained by compressing the powder were heated for 2 hours at 200° C. under a secondary vacuum in order to clean the surface of any impurity. The pellet was then put into contact with an excess of pyridine at a pressure of 1 Torr. The sample was then subjected to a primary and then a secondary vacuum so as eliminate any presence of any physisorbed pyridine and so as only to retain chemisorbed pyridine.

The infrared spectra of FIG. 3 are those obtained for a sample according to the invention (curve A) and for the comparative sample (stippled curve B). The presence may be seen of peaks with wave numbers 1640 cm⁻, 1540 cm⁻and 1490 cm⁻¹, characteristic of the protonation of pyridine. This protonation bears witness to a strong O—H—N bond between the surface of the particles and pyridine, a bond whose origin is in the presence of Brønsted sites. On the other hand, no trace of the protonation of pyridine was visible on the infrared spectra of the comparative sample, which demonstrated the absence of Brønsted sites. On the other hand, the presence of coordination bonds was observed visible for wave numbers 1593 cm⁻¹, 1574 cm⁻¹ and 1440 cm⁻¹. These bonds were the sign of the presence of Lewis sites.

The infrared spectra thus demonstrated the fact that the bonds between pyridine and the particles according to the invention were much stronger than the bonds observed with particles of the comparative sample, synthesized with SDS, this by virtue of the presence of Brønsted sites.

The result of this was a higher temperature for the complete desorption of pyridine in the case of particles according to the invention, notably above 150° C. The temperature for complete desorption could be determined by heating pellets prepared previously for 15 minutes at various temperatures: 50, 100 and then 150° C. The consequence of this heating was the desorption of chemisorbed pyridine. The presence or not of pyridine still chemisorbed was evaluated by infrared spectroscopy. In the case of the comparative sample, total desorption occurred at a temperature between 50 and 100° C. On the other hand, the sample according to the invention still contained chemisorbed pyridine at a temperature of 150° C.

The degradation mechanism for organic compounds by photocatalysis may be followed by spectroscopic methods in the visible region.

In order to do this, a sample of particles was added to an aqueous solution of rhodamine B. The concentration of rhodamine B was chosen so that after adsorption in the dark the absorbency of the solution was approximately 1. After stirring for one hour in the dark, the mixture was exposed to visible light.

The quantity of particles added to the solution was adapted so that the surface area of the particles was identical for the sample according to the invention and the comparative sample. Taking into account the difference in specific surface area, the quantity of particles according to the invention (0.125 g) was much smaller than the quantity of the comparative particles (0.5 g). Nevertheless, in both cases, rhodamine B was completely degraded at the end of 320 minutes. The invention thus made it possible to obtain an equivalent activity for a much smaller quantity of particles, or a much higher activity for the same quantity of particles.

The spectra obtained for the comparative sample were characterized by a reduction in the absorption intensity of the peak situated at wavelength 555 nm. Such a change was characteristic of degradation of the conjugated structure of the molecule by radical present in the aqueous solution.

On the other hand, the spectra obtained for the sample according to the invention were characterized essentially by a shift in the absorption peak to lower wavelengths, witnessing successive N-deethylation reactions. This degradation mechanism involved radicals present at the surface of the particles and not only in solution. This confirmed on the one hand better adsorption of organic molecules by particles according to the invention. On the other hand, this mechanism which involved the reaction of radicals present on the surface of the particles was much more effective in the absence of any liquid medium, for example when it consisted of decontaminating gases or making a surface self-cleaning. In other words, by virtue of the presence of Brønsted sites, better adsorption of organic molecules by particles according to the invention will greatly facilitate their subsequent degradation.

Layers comprising particles according to the invention were prepared as follows. The mixture comprising the particles and the dodecyl sulphate additive was deposited on a clear soda-lime-silica glass substrate by spin-coating. After the additive had been degraded by exposure to ultraviolet radiation for 24 hours, a layer was obtained consisting of particles of BiVO₄. The layers comprising the comparative particles were also prepared by spin-coating with a solution of particles in THF (tetrahydrofuran).

Photocatalytic activity was measured in the following way:
cutting out 5×5 cm samples,
measuring the infrared spectrum by FTIR for wave numbers between 4000 and 400 cm⁻¹, so as to prepare a reference spectrum,
depositing stearic acid: 60 microlitres of a solution of stearic acid dissolved at a rate of 10 g/L in ethanol was deposited on the sample by spin-coating,
measuring the infrared spectrum by FTIR, measuring the area of the elongation bands of CH₂—CH₂ bonds between 3000 and 2700 cm⁻¹,
exposing to radiation, namely UV+visible or only visible. The lamp used was a lamp simulating solar radiation (xenon arc lamp of the Suntest type), to which an anti-UV filter was added as the case required,
following the photodegradation of the stearic acid layer after successive periods of exposure of 30 minutes by measuring the area A of the elongation bands of CH₂—CH₃ bonds between 2980 and 2825 cm⁻¹.

A sign of the degradation of stearic acid was that the area A diminished linearly with time according to a coefficient k, defined as being the photocatalytic activity.

The photocatalytic activity of the layer under UV+visible radiation was of the order of 1.25×10⁻²×min⁻¹. In comparison, the photocatalytic activity of a 15 nm thick layer of titanium oxide deposited on a layer that was a barrier to alkalis was only 0.25×10⁻²×min⁻¹.

In the case of irradiation by only visible light, the photocatalytic activity was 6.2×10⁻³×min⁻¹. The photocatalytic activity of the layers comprising the comparative particles (synthesized with an addive) was 0.6×10⁻³×min⁻¹. The photocatalytic activity of a layer of titanium oxide under the same conditions was nil.

The particles according to the invention thus make it possible to obtain layers having very high photocatalytic activity under irradiation by visible light.

1. A method for producing particles having a chemical formula of BiVO₄, the method comprising:
reacting (i) a bismuth precursor, (ii) a vanadium precursor, and (iii) at least one additive selected from the group consisting of a sulphate surfactant comprising a hydrocarbon chain and a phosphonate surfactant comprising a hydrocarbon chain, at a reaction temperature below 50° C.

2. The method of claim 1, wherein the reaction temperature is ambient temperature.

3. The method of claim 1, wherein the reaction is carried out in an aqueous solution.

4. The method of claim 1, wherein the bismuth precursor is at least one selected from the group consisting of a bismuth nitrate and bismuth chloride.

5. The method of claim 1, wherein the vanadium precursor is at least one selected from the group consisting of ammonium vanadate and sodium vanadate.

6. The method of claim 1, wherein the hydrocarbon chain of the additive is a linear or branched alkyl chain comprising between 6 and 20 carbon atoms.

7. Particles having a chemical formula of BiVO₄, and comprising Brønsted sites on a particle surface.

8. The particles of claim 7, having an average diameter in a range between 500 nm to 5 micrometres.

9. The particles of claim 7, comprising a monoclinic phase crystal of the scheelite type and a quadratic phase crystal of the zircon type.

10. The particles of claim 7, having a specific surface area, determined by nitrogen adsorption with the aid of the BET method, of greater than or equal to 10 m²/g.

11. A substrate, comprising a layer on a substrate surface, wherein the layer comprises particles obtained by the method of claim 1.

12. The substrate of claim 11, wherein the particles are bound to the substrate with an organic binder.

13. The substrate of claim 12, wherein the inorganic binder comprises silica.

14. A glazing, a mirror, or a glass wall covering, comprising a substrate of claim 13.

15. A substrate, comprising a layer on a substrate surface, wherein the layer comprises the particles of claim 7.

16. The substrate of claim 15, wherein the particles are bound to the substrate with an inorganic binder.

17. The substrate of claim 16, wherein the inorganic binder comprises silica.

18. A glazing, a mirror, or a glass wall covering, comprising a substrate of claim 17.

19. The method of claim 4, wherein the bismuth precursor is bismuth nitrate pentehydrate.

20. The method of claim 5, wherein the vanadium precursor is sodium vanadate.
